(19) United States
(12) Patent Application Publication
(10) Pub. No.: US 2012/0126460 A1
(43) Pub. Date: May 24, 2012

(54) APPARATUS AND METHOD FOR MANUFACTURING BOARD FOR PRODUCTION OF METAL FLAKE

(75) Inventors: Ji Hwan SHIN, Yongin (KR); Jeong Min CHO, Seongnam (KR); Sung Kwon WI, Seoul (KR)

(73) Assignee: SAMSUNG ELECTRO-MECHANICS CO., LTD.

(21) Appl. No.: 13/036,387

(22) Filed: Feb. 28, 2011

(30) Foreign Application Priority Data
Nov. 18, 2010 (KR) 10-2010-0115290

(51) Int. Cl. B29C 59/04

(52) U.S. Cl. 264/495; 425/385; 264/293; 425/174.4

(57) ABSTRACT

There are provided an apparatus and method for manufacturing a board for the production of a metal flake. The apparatus includes: a base board supplying part; a patterning part forming a pattern layer on a base board supplied from the base board supplying part; a coating part forming a sacrificial layer on the base board having the pattern layer formed thereon, the sacrificial layer being decomposable by a solvent; and a base board recovering part recovering the base board having the sacrificial layer formed thereon.

### CROSS-REFERENCE TO RELATED APPLICATIONS

This application claims the priority of Korean Patent Application No. 10-2010-0115290 filed on Nov. 18, 2010, in the Korean Intellectual Property Office, the disclosure of which is incorporated herein by reference.

### BACKGROUND OF THE INVENTION

1. Field of the Invention

The present invention relates to an apparatus and method for manufacturing a board for the production of a metal flake, and more particularly, to an apparatus and method for manufacturing a board for the production of a metal flake having an easily adjustable thickness and uniform shape.

2. Description of the Related Art

In producing powdered metals, such as silver, copper, nickel, and aluminum mainly used in electrical and electronic products, a physical method and a chemical method are mainly employed. In the case of the physical method, there are a mechanical pulverizing method, a spray cooling method, and the like. However, these methods have a limitation on synthesizing fine metal powders. In the case of the chemical method, there are a liquid phase method and a vapor phase method. The liquid phase method using a reduction reaction may easily adjust granularity; it is, however, complicated and deteriorates crystallinity. Meanwhile, the vapor phase method is relatively superior in terms of crystallinity; it is, however, problematic in terms of controlling the size or shape of metal particles because the metal particles are formed by instantaneous reaction in a vapor phase.

These synthesizing methods are mainly used to produce spherically-shaped particles. In order to obtain flake-shaped particles, the spherical particles are manufactured as flake-shaped metal particles using a ball mill, or metals are subjected to vacuum evaporation.

A method of producing a metal flake with spherical metal particles using a ball mill, currently the most widespread method, may be relatively advantageous in terms of mass production; however, it has a difficulty in adjusting the shape and size of metal particles, deteriorates uniformity and puts limitations on producing a very thin metal flake of about several tens to several hundreds of nm in size.

### SUMMARY OF THE INVENTION

An aspect of the present invention provides an apparatus and method for manufacturing a board for the production of a metal flake, the shape, size and thickness of which are easily adjustable and the uniformity thereof is excellent.

According to an aspect of the present invention, there is provided an apparatus for manufacturing a board for production of a metal flake, the apparatus including: a base board supplying part; a patterning part forming a pattern layer on a base board supplied from the base board supplying part; a coating part forming a sacrificial layer on the base board having the pattern layer formed thereon, the sacrificial layer being decomposable by a solvent; and a base board recovering part recovering the base board having the sacrificial layer formed thereon.

The patterning part may include a resin supplying unit supplying a resin forming the pattern layer, a patterning unit including a patterning mold having a shape corresponding to that of the pattern layer, and a curing unit curing the pattern layer.

The patterning mold may be one of a belt-shaped mold, a flat panel-shaped mold, and a drum-shaped mold. In addition, the curing unit may be a UV curing furnace or a thermosetting furnace.

The coating part may include a coating solution supplying unit supplying a coating solution forming the sacrificial layer, a coating unit having a shape corresponding to that of the sacrificial layer, and a drying unit drying the sacrificial layer.

The coating unit may utilize one of a circular roller scheme, a spray scheme using a nozzle, a gravure roll scheme, and a bar coating scheme using a bar coater having a wire wound around a surface of a bar.

The sacrificial layer may be formed to cover the entirety of the pattern layer.

The pattern layer may have a lattice shape in which convex portions and concave portions are alternately formed. Here, the sacrificial layer may be formed on surfaces of the convex portions and the concave portions.

The pattern layer may made of a UV curable resin, and the sacrificial layer may be made of a resin other than the UV curable resin.

According to another aspect of the present invention, there is provided a method of manufacturing a board for production of a metal flake, the method including: preparing a base board; forming a pattern layer on the base board; forming a sacrificial layer on the pattern layer by applying a polymer material, decomposable by a solvent, to the patter layer; and recovering the base board having the sacrificial layer formed thereon.

The forming of the pattern layer may include supplying a resin forming the pattern layer to the base board; patterning the resin; and curing the patterned resin.

The patterning of the resin may be performed by using one of a flexible belt-shaped mold, a flat panel-shaped mold, and a drum-shaped mold having a shape corresponding to that of a pattern of the pattern layer. In addition, the curing of the patterned resin may be performed by UV curing or thermosetting.

The forming of the sacrificial layer may include applying the polymer material to the pattern layer; and drying the polymer material.

The applying of the polymer material may be performed by a spray coating method, a transfer printing method, or a contact application method.

The forming of the sacrificial layer may be performed by applying the polymer material to the pattern layer so as to cover the entirety thereof.

The forming of the pattern layer may be performed by causing the pattern layer to have a lattice shape in which convex portions and concave portions are alternately formed.

The forming of the sacrificial layer may be performed by applying the polymer material to surfaces of the convex portions and the concave portions.

The solvent may be water, alcohol, ketones, or oil.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view schematically showing an apparatus for manufacturing a board for the production of a metal flake according to an exemplary embodiment of the present invention;

FIG. 2 is a view showing a resin supplying unit in an apparatus for manufacturing a board for the production of a metal flake according to an exemplary embodiment of the present invention;

FIG. 3 is a view showing a first example of a patterning unit in an apparatus for manufacturing a board for the production of a metal flake according to an exemplary embodiment of the present invention;

FIG. 4 is a view showing a first example of a coating unit in an apparatus for manufacturing a board for the production of a metal flake according to an exemplary embodiment of the present invention;

FIG. 5 is a view showing a second example of a patterning unit in an apparatus for manufacturing a board for the production of a metal flake according to an exemplary embodiment of the present invention;

FIG. 6 is a view showing a third example of a patterning unit in an apparatus for manufacturing a board for the production of a metal flake according to an exemplary embodiment of the present invention;

FIG. 7 is a view showing a second example of a coating unit in an apparatus for manufacturing a board for the production of a metal flake according to an exemplary embodiment of the present invention;

FIG. 8 is a view showing a third example of a coating unit in an apparatus for manufacturing a board for the production of a metal flake according to an exemplary embodiment of the present invention;

FIGS. 9A through 9F are vertical cross-sectional views showing boards for the production of a metal flake according to various exemplary embodiments of the present invention; and

FIG. 10 is a flowchart showing a method of manufacturing a board for the production of a metal flake according to an exemplary embodiment of the present invention.

### DETAILED DESCRIPTION OF THE PREFERRED EMBODIMENT

Exemplary embodiments of the present invention will be described in detail with reference to the accompanying drawings. The exemplary embodiments of the present invention may be modified in many different forms and the scope of the invention should not be construed as being limited to the embodiments set forth herein. Rather, these embodiments are provided so that this disclosure will be thorough and complete, and will fully convey the concept of the invention to those skilled in the art. Further, throughout the drawings, the same or similar reference numerals will be used to designate the same components or like components having the same functions in the scope of the similar idea.

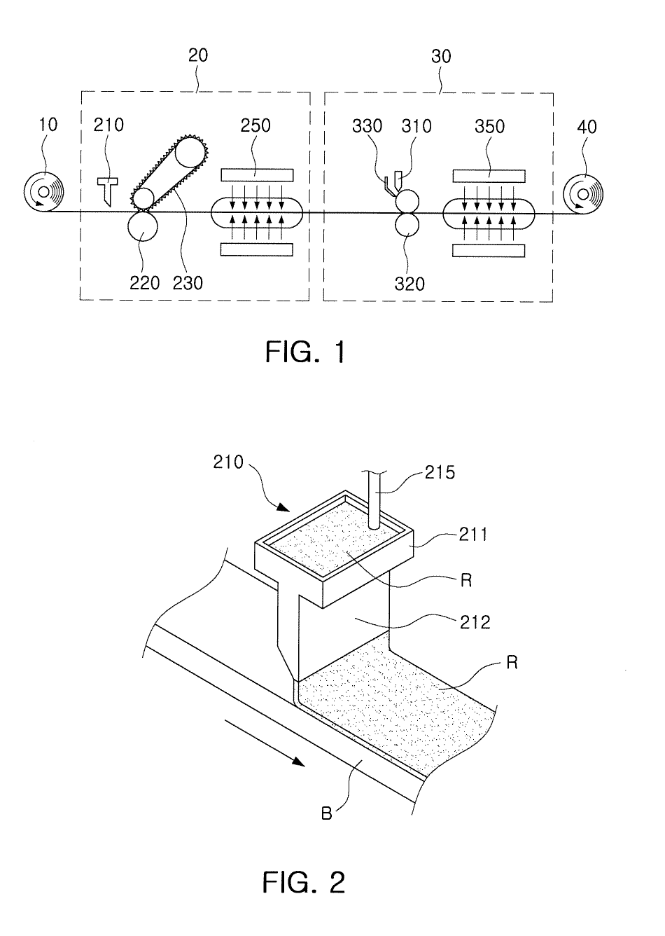

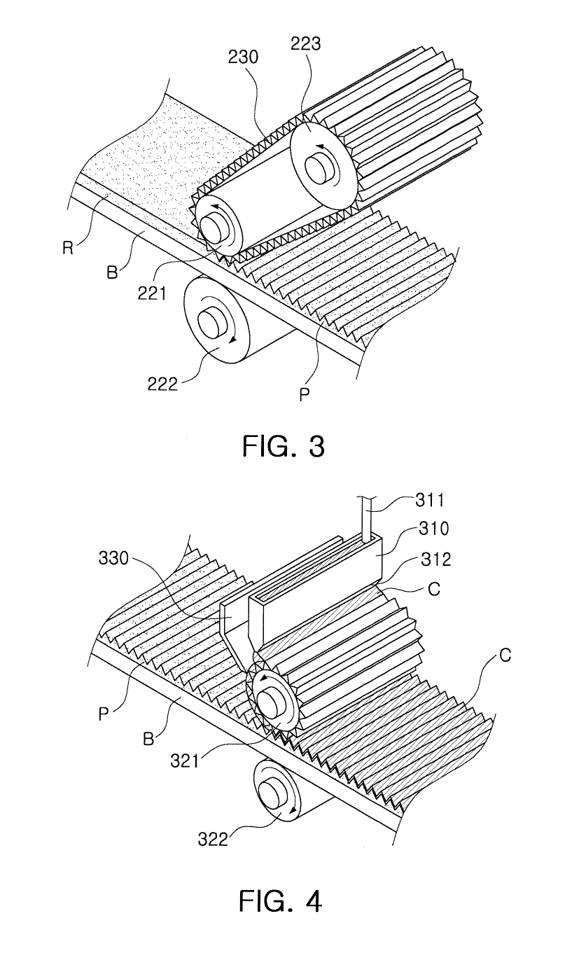

FIG. 1 is a view schematically showing an apparatus for manufacturing a board for the production of a metal flake according to an exemplary embodiment of the present invention; FIG. 2 is a view showing a resin supplying unit in an apparatus for manufacturing a board for the production of a metal flake according to an exemplary embodiment of the present invention; FIG. 3 is a view showing a first example of a patterning unit in an apparatus for manufacturing a board for the production of a metal flake according to an exemplary embodiment of the present invention; and FIG. 4 is a view showing a first example of a coating unit in an apparatus for manufacturing a board for the production of a metal flake according to an exemplary embodiment of the present invention.

Referring to FIG. 1, an apparatus for manufacturing a board for the production of a metal flake according to an exemplary embodiment of the present invention includes a base board supplying part 10, a patterning part 20, a coating part 30, and a base board recovering part 40.

The base board supplying part 10 is configured as a roller around which a flexible board such as polyethylene terephthalate (PET) is wound as a base board B, and the base board B is unwound from the roller.

The patterning part 20 may include a resin supplying unit 210 supplying a resin R forming a pattern layer P, a patterning unit 220 patterning the resin R, and a curing unit 250 curing the patterned resin.

Referring to FIG. 2, the resin supplying unit 210 may include a reservoir 211 storing the resin R supplied through a resin supplying pipe 215 and an outlet 212 discharging the resin R onto the base board B.

The patterning unit 220 includes a patterning mold 230 having a shape corresponding to that of the pattern layer P. As shown in FIG. 3, in the present embodiment, the patterning unit 220 may include the belt-shaped mold 230 having a shape corresponding to that of the pattern layer P on the flexible belt-shaped board. The patterning unit 220 forms a pattern on the resin R applied to the base board B in a roll-to-roll scheme, and includes an upper roller 221 disposed above the base board B, and a lower roller 222 disposed below the base board B, and a belt rotating roller 223 rotating the belt-shaped mold 230 together with the upper roller 221.

The curing unit 250 cures the pattern layer P having the pattern formed on the resin R applied to the base board B. The curing unit 250 maybe a UV curing furnace or a thermosetting furnace. Therefore, as for the resin R in the present embodiment a UV curable resin or a thermosetting resin may be used.

The coating part 30 may include a coating solution supplying unit 310 supplying a coating solution c forming a sacrificial layer C, a coating unit 320 having a shape corresponding to that of the sacrificial layer C, and a drying unit 350 drying the sacrificial layer C.

The coating unit 320 may use any one of a circular roller scheme, a spray scheme using a nozzle, a gravure roll scheme, and a bar coating scheme using a bar coater having a wire wound around a surface of a bar. In the present embodiment, the gravure roll scheme is used as shown in FIG. 4.

Referring to FIG. 4, the coating solution supplying unit 310 discharges the coating solution c, supplied through a coating solution supplying pipe 311, through an outlet opening 312, and the coating unit 320 in the gravure roll scheme includes a casting roll 321 having a shape corresponding to that of the sacrificial layer C and a supporting roll 322 disposed below the base board B. The coating solution, supplied from the coating solution supplying unit 310, may be uniformly supplied to the casting roll 321 using a doctor blade 330.

The drying unit 350 dries the coating solution c applied to the pattern layer P to complete the sacrificial layer C.

The coating solution c, forming the sacrificial layer C, may be made of a polymer material decomposable by an organic solvent such as water, alcohol or ketones, or oil. When the pattern layer P is cured by the UV curing, a resin other than the UV curable resin may be used for the sacrificial layer C.

As for the polymer material forming the sacrificial layer C, ethylcellulose, polyvinyl butyral (PVB,), or polyvinyl alcohol (PVA) may be used.

The sacrificial layer C is used to separate a metal layer, formed on the sacrificial layer C by sputtering, plating, or the like in producing the metal flake, from the base board.

The base board recovering part 40, which recovers the base board B on which the pattern layer P and the sacrificial layer (C) are sequentially formed, allows the base board B to be wound therearound at the same speed as the unwinding speed of the base board supplying part 10.

As such, according to the present embodiment, a metal flake having a desired shape maybe produced by using patterning molds having various shapes, and the separation of the metal layer may be facilitated by decomposing the sacrificial layer after the metal layer is formed.

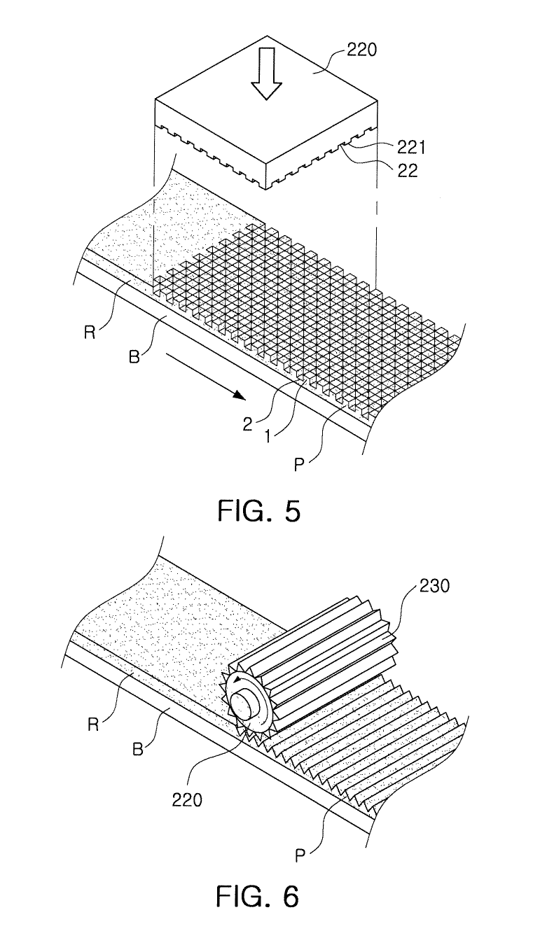

FIG. 5 is a view showing a second example of a patterning unit in an apparatus for manufacturing a board for the production of a metal flake according to an exemplary embodiment of the present invention, and FIG. 6 is a view showing a third example of a patterning unit in an apparatus for manufacturing a board for the production of a metal flake according to an exemplary embodiment of the present invention.

Referring to FIG. 5, the patterning unit 220 is a flat panel-shaped mold and has a patterning mold having a shape corresponding to that of the pattern layer P and formed on a surface contacting the resin R. In the present embodiment, the patterning mold includes convex portions 221 and concave portions 222 having a shape corresponding to that of the pattern layer P so that the pattern layer P has a lattice shape in which convex portions 1 and concave portions 2 are alternately formed.

Referring to FIG. 6, the patterning unit 220 is a drum-shaped mold, and a pattern having a shape corresponding to that of the pattern layer P is formed on a main surface of the drum-shaped mold 220.

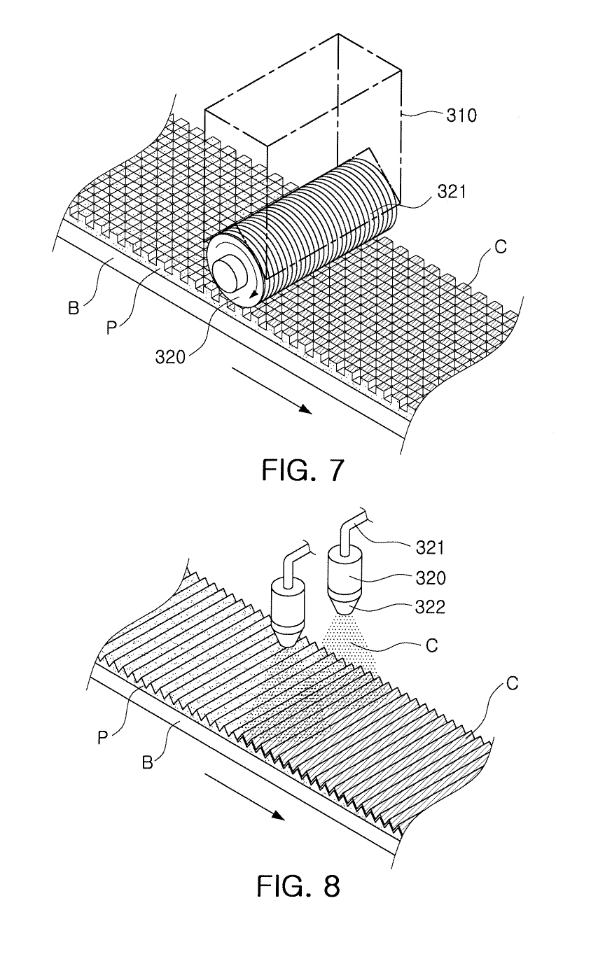

FIG. 7 is a view showing a second example of a coating unit in an apparatus for manufacturing a board for the production of a metal flake according to an exemplary embodiment of the present invention, and FIG. 8 is a view showing a third example of a coating unit in an apparatus for manufacturing a board for the production of a metal flake according to an exemplary embodiment of the present invention.

Referring to FIG. 7, in the present embodiment, the coating unit 320 uses a bar coating scheme. A bar coater 320 having a wire wound around a surface thereof is rotated to form the sacrificial layer C on the pattern layer P.

Referring to FIG. 8, in the present embodiment, the coating unit 320 uses a spray scheme. The coating solution c, supplied through a coating solution supplying pipe 321, is sprayed to the pattern layer P through a nozzle 322 to form the sacrificial layer C.

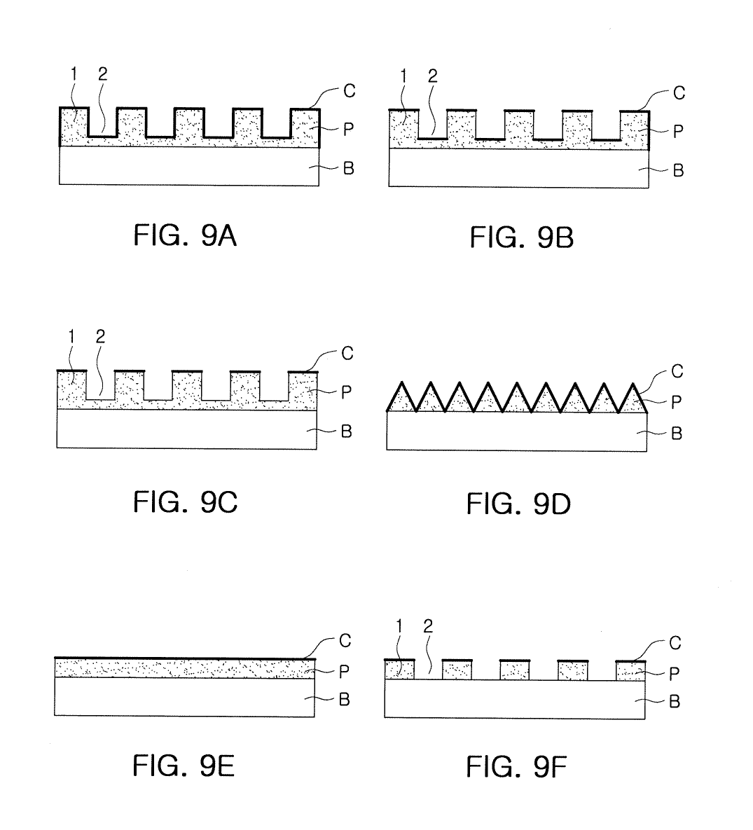

FIGS. 9A through 9F are vertical cross-sectional views showing boards for the production of a metal flake according to various exemplary embodiments of the present invention.

Referring to FIG. 9A, the pattern layer P has a lattice shape in which the convex portions 1 and the concave portions 2 are alternately formed, and the sacrificial layer Cis formed to cover the entirety of the pattern layer P.

In the exemplary embodiment shown in FIG. 9B, the pattern layer P has a lattice shape in which the convex portions 1 and the concave portions 2 are alternately formed, and the sacrificial layer C is applied to surfaces of the convex portions 1 and the concave portions 2 of the pattern layer P.

In the exemplary embodiment shown in FIG. 9C, the pattern layer P has a lattice shape in which the convex portions 1 and the concave portions 2 are alternately formed, and the sacrificial layer (C) is applied to only the surfaces of the convex portions 1 of the pattern layer P.

In the exemplary embodiment shown in FIG. 9D, the pattern layer P has triangular vertical sections, and the sacrificial layer C is formed to cover the entirety of the pattern layer P.

In the exemplary embodiment shown in FIG. 9E, the pattern layer P is formed to have a flat panel shape, and the sacrificial layer C is applied to an upper surface of the pattern layer P.

In the exemplary embodiment shown in FIG. 9F, the pattern layer P has the convex portions 1 with predetermined intervals therebetween, and the sacrificial layer C is applied to only the surfaces of the convex portions 1 of the pattern layer P. In the present embodiment, the concave portions 2 are formed without the pattern layer P or the sacrificial layer C.

Although the shapes of the boards for the production of a metal flake according to the various exemplary embodiments of the present invention have been described, the present invention is not limited thereto. Metal flakes having desired shapes may be produced by manufacturing patterning molds and coating units having various shapes.

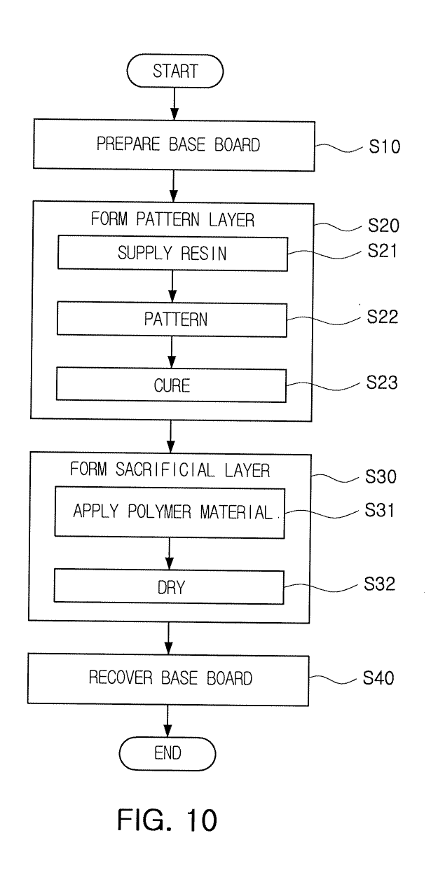

FIG. 10 is a flowchart showing a method of manufacturing a board for the production of a metal flake according to an exemplary embodiment of the present invention.

First, a base board B is prepared (S10). The base board B may be a flexible board such as PET. The base board B, wound around a supplying roller, may be unwound therefrom.

When the base board B, unwound from the supplying roller, is supplied, a pattern layer P is formed on the base board B (S20). The forming of the pattern layer P on the base board B (S20) includes supplying a resin R to the base board B (S21), patterning the resin R using a patterning mold (S22), and curing the patterned resin R (S23). In this manner, when the patterned resin is cured, the pattern layer P is formed.

The patterning of the resin (S22) may be performed by using any one of a flexible belt-shaped mold, a flat panel-shaped mold, and a drum-shaped mold having a shape corresponding to that of a pattern of the pattern layer P.

The curing of the patterned resin (S23) may be performed by UV curing or thermosetting. Accordingly, as for the resin R, a UV curable resin or a thermosetting resin may be used.

Then, a sacrificial layer C is formed on the pattern layer P (S30). The forming of the sacrificial layer C (S30) includes applying a polymer material to the pattern layer P (S31) and drying the polymer material (S32). The polymer material may be decomposable by an organic solvent, such as water, alcohol or ketones, oil, or the like.

The applying of the polymer material (S31) may be performed by a spray coating method using a nozzle, a transfer printing method using a gravure roll, or a contact application method using a bar coater.

The applying of the polymer material (S31) may be performed by applying the polymer material to cover the entirety of the pattern layer P or applying the polymer material to a portion of a predetermined pattern of the pattern layer P. For example, when the pattern layer P has a lattice pattern in which convex portions 1 and concave portions 2 are alternately formed, the polymer material may be applied to cover the entirety of the convex portions 1 and the concave portions 2, may be applied to only surfaces of the convex portions 1 and the concave portions 2, or maybe applied to only the surfaces of the convex portions 1. Accordingly, this may be changed according to various design specifications.

Next, the base board B having the pattern layer P and the sacrificial layer C sequentially formed thereon is recovered (S40). The base board B may be wound around a recovering roller rotating at substantially the same speed as that of the supplying roller.

The base board B manufactured as described above is used to produce a metal flake. A process of producing the metal flake is as follows: a metal layer is formed on the sacrificial layer C through a sputtering method, an electroforming method, a thermal evaporation method, an electron beam evaporation method, or the like; the sacrificial layer C is removed by being decomposed using an organic solvent, such as water, alcohol or ketones, or oil; and the metal layer is separated from the base board B, and thus individual metal flakes are produced.

Here, since the pattern layer corresponding to a metal flake having a desired shape is previously formed and the metal layer is formed on the pattern layer, the shape, size or thickness of the metal flake may be easily adjustable.

As set forth above, in an apparatus and method for manufacturing a board for the production of a metal flake according to exemplary embodiments of the present invention, the shape, size and thickness of a metal flake are easily adjustable and the superior uniformity thereof is achieved.

While the present invention has been shown and described in connection with the exemplary embodiments, it will be apparent to those skilled in the art that modifications and variations can be made without departing from the spirit and scope of the invention. For example, the shape of a patterning mold or a method of coating a sacrificial layer are taken as examples, and patterning molds having various shapes and patterning and coating methods in various schemes may be used. Accordingly, the actual scope of the present invention should be defined by the appended claims.

What is claimed is:

1. An apparatus for manufacturing a board for production of a metal flake, the apparatus comprising:
a base board supplying part;
a patterning part forming a pattern layer on a base board supplied from the base board supplying part;
a coating part forming a sacrificial layer on the base board having the pattern layer formed thereon, the sacrificial layer being decomposable by a solvent; and
a base board recovering part recovering the base board having the sacrificial layer formed thereon.

2. The apparatus of claim 1, wherein the patterning part comprises:
a resin supplying unit supplying a resin forming the pattern layer;
a patterning unit including a patterning mold having a shape corresponding to that of the pattern layer; and
a curing unit curing the pattern layer.

3. The apparatus of claim 2, wherein the patterning mold is one of a belt-shaped mold, a flat panel-shaped mold, and a drum-shaped mold.

4. The apparatus of claim 2, wherein the curing unit is a UV curing furnace or a thermosetting furnace.

5. The apparatus of claim 1, wherein the coating part comprises:
a coating solution supplying unit supplying a coating solution forming the sacrificial layer;
a coating unit having a shape corresponding to that of the sacrificial layer; and
a drying unit drying the sacrificial layer.

6. The apparatus of claim 5, wherein the coating unit utilizes one of a circular roller scheme, a spray scheme using a nozzle, a gravure roll scheme, and a bar coating scheme using a bar coater having a wire wound around a surface of a bar.

7. The apparatus of claim 1, wherein the sacrificial layer is formed to cover the entirety of the pattern layer.

8. The apparatus of claim 1, wherein the pattern layer has a lattice shape in which convex portions and concave portions are alternately formed.

9. The apparatus of claim 8, wherein the sacrificial layer is formed on surfaces of the convex portions and the concave portions.

10. The apparatus of claim 1, wherein the pattern layer is made of a UV curable resin, and
the sacrificial layer is made of a resin other than the UV curable resin.

11. A method of manufacturing a board for production of a metal flake, the method comprising:
preparing a base board;
forming a pattern layer on the base board;
forming a sacrificial layer on the pattern layer by applying a polymer material, decomposable by a solvent, to the pattern layer; and
recovering the base board having the sacrificial layer formed thereon.

12. The method of claim 11, wherein the forming of the pattern layer comprises:
supplying a resin forming the pattern layer to the base board;
patterning the resin; and
curing the patterned resin.

13. The method of claim 12, wherein the patterning of the resin is performed by using one of a flexible belt-shaped mold, a flat panel-shaped mold, and a drum-shaped mold having a shape corresponding to that of a pattern of the pattern layer.

14. The method of claim 12, wherein the curing of the patterned resin is performed by UV curing or thermosetting.

15. The method of claim 11, wherein the forming of the sacrificial layer comprises:
applying the polymer material to the pattern layer; and
drying the polymer material.

16. The method of claim 15, wherein the applying of the polymer material is performed by a spray coating method, a transfer printing method, or a contact application method.

17. The method of claim 11, wherein the forming of the sacrificial layer is performed by applying the polymer material to the pattern layer so as to cover the entirety thereof.

18. The method of claim 11, wherein the forming of the pattern layer is performed by causing the pattern layer to have a lattice shape in which convex portions and concave portions are alternately formed.

19. The method of claim 18, wherein the forming of the sacrificial layer is performed by applying the polymer material to surfaces of the convex portions and the concave portions.

20. The method of claim 11, wherein the solvent is water, alcohol, ketones, or oil.
